(19) United States
(12) Patent Application Publication
(10) Pub. No.: US 2003/0088773 A1
(43) Pub. Date: May 8, 2003

(54) Method of and apparatus for preventing illicit copying of digital content

(75) Inventor: Laszlo Hars, Cortlandt Manor, NY (US)

Correspondence Address: Jack Slobod, U.S. Philips Corporation, 580 White Plains Road, Tarrytown, NY, 10591, US

(73) Assignee: KONINKLIJKE PHILIPS ELECTRONICS N. V.

(21) Appl. No.: 09/986,102

(22) Filed: Nov. 7, 2001

(51) Int. Cl. H04L 9/00

(52) U.S. Cl. 713/176

(57) ABSTRACT

Watermarks WM₁ . . . WMₖ . . . WM_{N} are applied to sections 1 . . . k . . . N of digital media content on a recording medium having an identification number (CDID) by combining numerical values representing CDID, N and i in accordance with a concatenated hashing function, to derive a numerical value for WM_{[1]i}. The numerical value for WMₗ is applied to section i, where i is selectively each of 1 . . . N. The watermark of section j is checked by determining the numerical values of CDID, j and N from the read digital media content and determining the watermark WMⱼₐ actually read from section j. The determined numerical values of CDID, j and N are combined by using the same hashing function that is used to derive WMₗ to derive a digital signal for the watermark WMⱼᵣ read from section j. The digital signal for watermark WMⱼᵣ that should be read from section j is compared with an indication of the numerical value for the watermark WMⱼₐ actually read from section j. If CDID is read directly from the medium, the WMⱼᵣ that should be read from section j is derived from H(CDID⋄N⋄j) where H is the hashing number and ⋄ is the concatenation of numbers. If CDID can be read directly, H(CDID) is determined by modular subtraction of H(N⋄k) from the value of WMⱼₐ actually read from section j.

### FIELD OF THE INVENTION

The present invention relates generally to a method of and apparatus for watermarking digital content, to a record resulting from such watermarking, and to reading such a watermarked record, and more particularly, to watermarking sections of the digital content by hashing a concatenated combination of digital signals representing linking information about the watermarked digital media content, e.g., an identification number for the record, the numbers of the sections in the record and the total number of sections in the record.

### BACKGROUND ART

The popularity of both the Internet and digital media technologies (e.g., compact disks “CDs” and digital versatile disks “DVDs”) has created tremendous problems for copyright owners of digital media content. The ability to reproduce, play and transmit digital content has become readily available to anyone with a personal computer and access to the Internet. This ability has led to widespread abuses to the rights of copyright owners who are unable to stop the illegal reproduction of their works.

One particular area where copyright ownership is particularly abused involves the music industry. The illicit pirating of digital music across the Internet is causing immeasurable damage to the music industry. Heretofore, most music content has been packaged and stored in an open, unsecured format that can be read and processed by any digital media player or recorder, i.e., content can be readily reproduced, stored and transmitted. To address this, the music industry has sought to create a secure domain to control the rampant pirating of music.

One solution the music industry is exploring involves establishing standards for secure playback and recording devices that process specially encoded content. Numerous secure devices and systems have been proposed. For instance, U.S. Pat. No. 5,513,260, issued on Apr. 30, 1996, entitled “Method and Apparatus For Copy Protection For Various Recording Media,” describes a system in which an authorization signature is required before a protected CD can be played. PCT application WO 99/60568, published on Nov. 25, 1999, entitled “Copy Protection Using Broken Modulation Rules,” also discloses various anti-pirating systems. Each of these references is hereby incorporated by reference.

In addition, a group referred to as SDMI (Secure Digital Music Initiative), made up of more than 180 companies and organizations representing information technology, consumer electronics, telecommunication, security technology, the worldwide recording industry, and Internet service providers, is attempting to develop standards and architectures for secure delivery of digital music in all forms. Information regarding SDMI can be found at their website at <www.sdmi.org>.

One of the challenges with implementing compliant systems, such as those sought under SDMI, is that various competing requirements must be met. For instance, under SDMI: (1) people must be allowed to make an unlimited number of personal copies of their CDs if in possession of the original CD; (2) SDMI-compliant players must be able to play music already in a library; (3) SDMI must provide the ability to prevent large numbers of perfect digital copies of music; and (4) SDMI must prevent the distribution on the Internet without any compensation to the creator or copyright holder. Thus, SDMI requires that a limited form of copying must be allowed, while at the same time widespread copying must be prohibited.

Unfortunately, such competing requirements create opportunities for hackers and pirates to defeat the protection schemes of the systems. Accordingly, protection schemes that are difficult to defeat, but will meet the open requirements for initiatives such as SDMI, have and are being developed.

My co-pending, commonly assigned application Ser. No. 09/730,336, filed Dec. 5, 1999, incorporated herein by reference, discloses a method of and apparatus for imposing a degree of difficulty on illicitly copying digital media content. This application, as well as other prior art, discloses the use of watermarks for imposing a degree of difficulty on illicitly copying digital media content. The watermarks are in the form of coded digital signals interspersed during the process of putting the digital media content on a recording medium, such as a CD or DVD. Typically, the digital content from the recording medium is partitioned into sections having durations of about 7 to 30 seconds. The watermarks are placed in the digital media content with different coding and/or levels at different locations such that the effects of the watermarks are not perceptible to a typical listener of the digital media content. The watermarks are designed to prevent illicit copying of the digital media content because illicitly copied and modified digital media content from the Internet or a CD or DVD onto a recording medium, such as a CD or a hard disk of a personal computer, does not include a correct and/or complete sequence of such watermarks. Typical modification of the content at illicit copying includes compression (e.g. MP3) or truncation (only a song is copied from a CD, not the entire medium). Playback devices responsive to the copied digital media content are equipped with signal processors which prevent readout of at least a portion of the digital media content which does not include the correct sequence of such watermarks.

For example, music is typically delivered on audio CDs including a collection of tracks or songs. Illicit copying of such CDs is often limited to a small subset of the songs on a particular CD. In my previously mentioned application, such illicit copying is made considerably more difficult because a complete collection of tracks and watermarks must be present before a portion of an audio CD can be reproduced.

In one prior art approach disclosed in the co-pending, commonly assigned application of Michael A. Epstein and Toine Staring, entitled “Method and Apparatus for Secure Content and Distribution, filed Feb. 7, 2000, Ser. No. 09/498,883 (incorporated herein by reference), the watermark for each section including a watermark includes an identification number for a recording on which the digital media content is stored, typically a CD, the number of the section, and the total number of sections in a recording or in a track of the recording. A problem that has occurred in using the prior art approach disclosed by Epstein et al. is that the watermark must encode an excessive number of bits, such as 60 to 80. Consequently, there is a tendency for the watermark to become audible to at least some listeners during playback. As a result, it is desirable to reduce the number of bits in such watermarks to a lower number, such as 20-24. The number of bits cannot be excessively reduced to a number such as 10 because such a reduction would enable the watermarking technique to be compromised by a hacker using a so-called dictionary attack. The number of bits must be reduced in a manner and to an extent such that the watermarking technique cannot be easily attacked.

It is, accordingly, an object of the present invention to provide a new and improved method of and apparatus for applying watermarks to a record, such as a CD, including digital media content.

Another object of the present invention is to provide a new and improved method of and apparatus for determining if watermarks read from a record including digital content have desired values.

A further object of the invention is to provide a new and improved record including digital content in numbered sections including difficult to attack watermarks that are relatively short and which include numerical information derived from an identification number of the record, the number of the section, and the total number of sections in the record or a track of the record forming a song.

An additional object of the invention is to provide a new and improved method of and apparatus for applying difficult to attack watermarks to a record, wherein the watermarks are relatively short and include numerical information derived from an identification number of the record, the number of the section, and the total number of sections in the record or a song included in a track of a record.

Yet another object of the present invention is to provide a new and improved method of and apparatus for determining if difficult to attack, relatively short watermarks embedded in digital content sections on a record have correct values, wherein the watermarks include numerical information derived from an identification number of the record, a number of the section and the total number of sections in the record or a song included in a track of a record.

### SUMMARY OF THE INVENTION

In accordance with one aspect of the present invention, watermarks WM₁ . . . WMₖ . . . WM_{N} are applied to sections of 1 . . . k . . . N of digital content on a recording medium having an identification number (CDID) by combining numerical values representing CDID, N and k in accordance with a concatenated hashing function to derive a numerical value for WMₗ. The numerical value for WMₗ is applied to section i, where i is selectively each of 1 . . . N.

Another aspect of the invention relates to a method of checking the watermark of section j of read digital content in a record having watermarks applied by combining numerical values representing CDID, N and k in accordance with a concatenated hashing function to derive a numerical value for WMⱼ where CDID is an identification number of the record, N is the number of sections in the record and j is the number of a particular section. The checking is performed by determining the numerical values of CDID, j and N from the read digital content and determining the watermark WMⱼₐ actually read from section j. The determined numerical values of CDID, j and N are combined by using the same hashing function that is used to derive WMₗ to derive a digital signal for the watermark WMⱼᵣ that should be read from section j. The digital signal for the watermark WMⱼᵣ that should be read from section j is compared with an indication of the numerical value for the watermark WMⱼₐ actually read from section j.

If CDID is read directly from the medium, the WMⱼᵣ that should be read from section j is derived from H(CDID⋄N⋄j), where H is the hashing function and 0 is the concatenation of numbers.

The correctness of the recorded CDID is determined by performing a calculation on value WMⱼₐ actually read from section j. H(CDID) is determined by subtracting H(Nⱼ) from the value of WMⱼₐ actually read from section j.

If CDID cannot be read directly from the medium, WMᵢ is derived from the EXCLUSIVE OR (XOR) combination of H(CDID) and H(N⋄j). This method involves two calls of the hash function H, therefore some additional computation is involved. Here XOR means bit-wise exclusive or on the binary representations of its two operands. The XOR operation can be replaced by any invertible 2 argument operation, e.g., a complementary exclusive or function or a modular addition function.

A further aspect of the invention relates to a recording medium assigned with an ID number (CDID), wherein the medium includes digital content, and at least some of the digital content includes recorded watermarked sections 1 . . . i . . . N. The watermark in section i has a numerical value in accordance with a hashed concatenated function of CDID, N and i.

The above and still further objects, features and advantages of the present invention will become apparent upon consideration of the following detailed description of a specific embodiment thereof, especially when taken in conjunction with the accompanying drawings.

### BRIEF DESCRIPTION OF THE DRAWING

FIG. 1 is a schematic and block diagram of a recorder in accordance with a preferred embodiment of the invention;

FIG. 2 is a flow diagram of operations performed by a signal processor included in the recorder of FIG. 1;

FIG. 3 is a schematic and block diagram of a playback device in accordance with a preferred embodiment of the invention; and

FIG. 4 is a flow diagram of operations performed by a signal processor included in the playback device of FIG. 3.

### DETAILED DESCRIPTION OF THE DRAWING

Reference is now made to FIG. 1 of the drawing wherein recorder 10 is illustrated as including write head 12 for applying digital signals to compact disc 14 in a conventional manner. The digital signals are in the form of digital media content, typically songs or other musical compositions, written into tracks 16 on compact disc 14, such that each song is written into a separate track. Write head 12 responds to digital output signals of conventional modulator 18, in turn responsive to signal processor 20, driven by digital media content source 22. Digital media content source 22 is typically a compact disc (CD), a digital versatile disc (DVD), or a computer, all of which store digital signals resulting from a musical performance.

The signal that digital media content source 22 derives includes watermarks designed to prevent illicit copying of the digital media content of source 22. The digital media content of source 22 for a media track 16 or for the entire CD14 is divided into a number of consecutively numbered sections, having a predetermined duration, typically between 7 and 30 seconds. In one embodiment, each section includes a watermark; in another embodiment, only some, e.g., alternate, sections include watermarks. A header associated with each of the tracks or an entire record (e.g., an entire CD or DVD) includes digital signals for enabling proper detection of a sequence of the watermarks, as disclosed, e.g., in the previously mentioned co-pending applications. The header can also signal that there is no copyright protection for the digital media content, so copying thereof is permitted. The header also includes a digital signal representing the total number of sections in a record track.

Signal processor 20 responds to the digital media content of source 22 and a digital signal from source 23 indicative of an identification number (CDID) for CD 14 to derive watermarks that prevent a song or track that is recorded on CD 14 from being illicitly read from CD 14 and stored or recorded elsewhere. Processor 20 derives for each section of the track or record that is to be watermarked a multi-bit digital signal. The digital signal results from hashing a concatenated combination of binary bits representing the identification number (CDID), the number (i) of the particular section and the total number (N) of sections in the song or the record, i.e., CD 14.

Without a hashing function, the number of binary bits resulting from the concatenation of the identification number (CDID), the section number (i) and the total number (N) of sections in the song or the record would be excessively large, for example, between 60 and 80. The hashing function is selected so that the number of binary bits resulting from the concatenation is reduced to between 20 and 24, a number sufficiently small so that embedding it via watermarks does not adversely affect the quality of a song played back from CD 14 and sufficiently large as to defeat attempts by hackers to illicitly copy a song recorded on CD 14. While the hashing function need not be complicated, it must be such that: (1) any two sections of the same or different CDs have hash values that are different with a very large probability; (2) consecutive sections of the same CD have hash values that are substantially different from each other; and (3) changing the number of sections in a song or on CD 14 results in a large and very unpredictable change in the hash values for a particular section. For example, the hashing function can be the truncated check sum of the concatenated binary bits, cyclic redundant checksums (CRC), or a function that can be implemented at high speed by existing hardware, such as “exhort” which is advantageous because it does not have carry propagation.

The watermarking is such that any tampering with the total number of sections (N) in a track or CD results in a watermark for a particular section which does not have the correct value. In addition, using sections from another CD or different sections of the same CD results in a watermark for a particular section, which does not match the correct value for that section. If a hacker attempts to substitute a section from another CD (i.e., the wrong CD) with a watermark identical to the watermark of the section recorded on CD 14, other sections of the wrong CD almost never work as substitutes.

Signal processor 20, in addition to responding to digital media content source 22, responds to header source 24 which derives digital signals representing certain data to be applied to a header of CD 14 and/or to a header associated with each of the tracks of the CD 14. The signals that source 24 applies to processor 20 include numerical representations of the number (CDID) identifying the particular CD on which the digital media content is being recorded, as well as the number of sections (N) to be recorded in CD 14 or the number of sections (N) in a track to be recorded in CD 14.

Signal processor 20 can be any suitable programmed processor or part of a programmed central processing unit (CPU). In any event, signal processor 20 includes registers for storing various digital signals and includes hardware programmed to calculate the hashing function resulting from the concatenation of CDID, N, and i, where i is the number of a particular section of the digital media content that source 22 derives and selectively has every value from 1 to N.

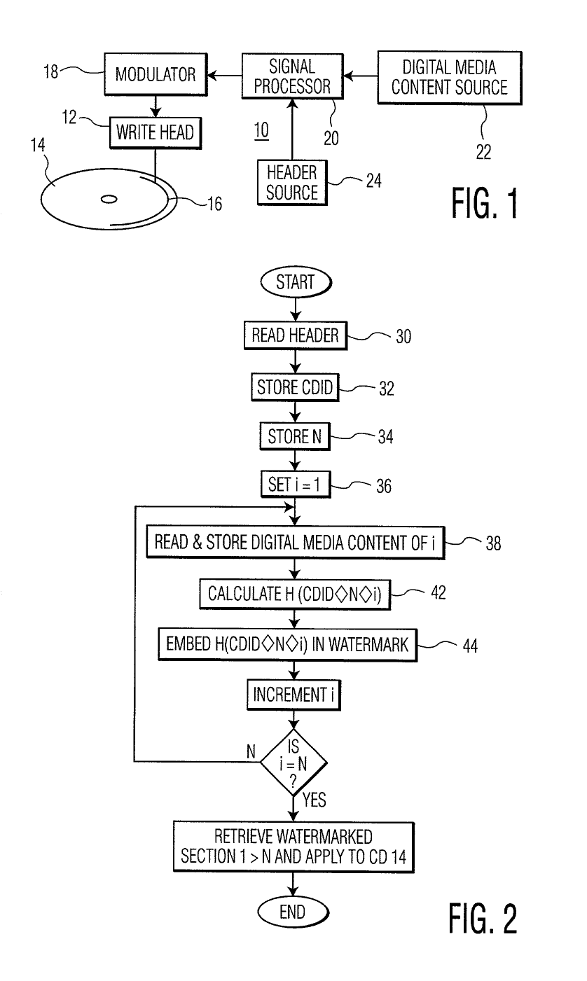

FIG. 2 is a flow diagram of the applicable operations signal processor 20 performs to apply watermarked sections of the digital media content to CD 14 tracks. Initially, during operation 30, signal processor 20 reads and stores the header that signal source 24 derives. Consequently, the values of CDID and N are stored in appropriate registers in processor 20, as respectively indicated by operations 32 and 34. Then signal processor 20 sets an index register to i=1, as indicated by operation 36. The initial conditions for processor 20 determining the watermarks of the digital media content to be applied to CD 14 tracks are thereby established.

Processor 20 then reads and stores the digital media content of section i, operation 38. Since each of the sections of a particular media track has the same duration, typically 7 to 30 seconds, operation 38 is periodically performed on the digital media content of each section. Processor 20 then, during operation 42, concatenates CDID, N and i in accordance with CDID⋄N⋄i and hashes the results in accordance with a hashing function, as discussed previously. A digital signal having between 20 and 24 bits in accordance with H(CDID⋄N⋄i) is thereby derived. Processor 20 then, during operation 44, embeds the resulting digital signal representing H(CDID⋄N⋄i) in section i. Processor 20 then, during operation 46, increments the index register to i=i+1.

The operations associated with determining and storing the watermark for section i have thus been completed. Processor 20 then determines if the last section to be recorded in CD 14 or the track of CD 14 has been reached by determining, during operation 48, if i=N. If i is not equal to N, the program of processor 20 returns to operation 38, causing operations 38-48 to be repeated until i=N. When operation 48 indicates that the last section to be recorded has been reached, that is, i=N, the processor advances to operation 50, during which the stored header and watermarked sections 1 . . . i . . . N are retrieved and sequentially applied to CD 14.

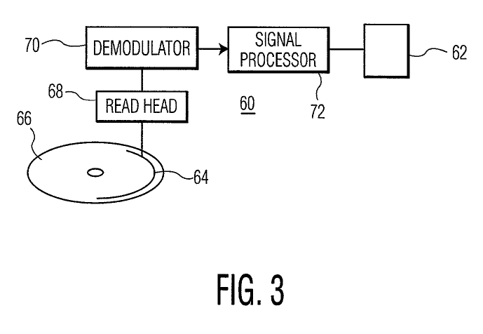

Reference is now made to FIG. 3 of the drawing, a schematic and block diagram of playback unit 60 having provisions for preventing meaningful reproduction by loudspeaker 62 of track 64 illicitly copied on CD 66 and for providing meaningful reproduction by the speaker of tracks lawfully copied on the CD. Playback unit 60 includes conventional read head 68 for deriving digital signals indicative of digital media content read from a track on CD 66. The digital output signals of read head 68 drive conventional demodulator 70, which in turn supplies digital signals indicative of the digital media content, and the watermarks embedded therein, of the track of CD 66 read to signal processor 72. Signal processor 72 includes a digital to analog converter capable of deriving an analog music signal that drives loudspeaker 62.

Each track of CD 66 or the entire CD 66 includes a header including the CD identification number, and the number of sections in the track or CD. Signal processor 72 responds to the header, the digital media content and the watermarks embedded in the digital media content to determine if the track or the entire CD has been illicitly copied or is a legal copy of the original digital media content. If signal processor 72 is able to read the CD identification number it calculates a hashed function for each section of the digital media content in accordance with: H(CDID⋄N⋄i) and compares the calculated hashed function with the hashed watermark embedded in the digital media content for the section. If signal processor 72 is unable to read the CD identification number, it determines the CD identification number by performing a modular subtraction of H(N⋄k) from WMₖₐ, where k is the number of section k and WMₖₐ is the watermark actually read from section k. After the track or entire CD 66 has been read and processed by signal processor 72, the signal processor determines if the track or the entire CD has been illicitly copied or is a legal copy of the original digital media content. If the track or the entire CD has been illicitly copied, signal processor 72 prevents application of the track and/or entire CD to speaker 62.

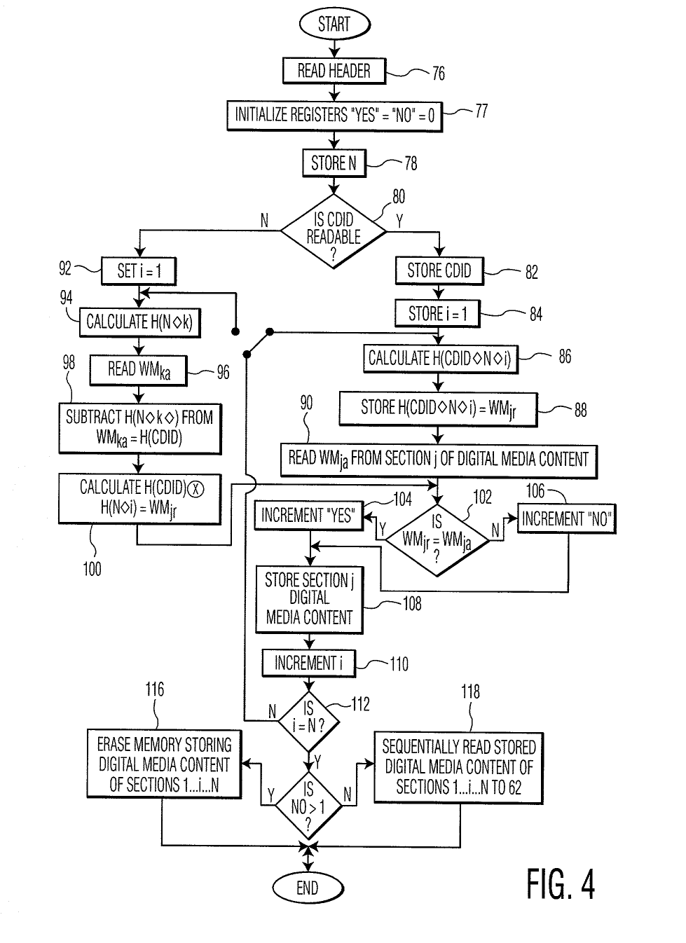

FIG. 4 is a flow diagram of operations signal processor 72 performs to achieve the above results. Initially, during operation 76, processor 72 reads a header of the track or the header of the entire CD. Then, during operation 77, processor 72 initializes YES and NO registers included thereon so both registers store zero values. Processor 72 then steps to operation 78, during which the processor determines from the header the number of sections in the track or the entire CD and stores this number, N, in a register of the processor.

Processor 72 then steps to operation 80, during which the processor determines if CDID in the header of the track or the CD is readable. If the CDID in the header is readable, processor 72 advances to operation 82 during which the processor stores CDID in another register of the processor. Processor 72 then advances to operation 84 during which the processor sets an index register to i=1. The number in the index register represents the number of the section in the track or CD that is being processed. Processor 72 then steps to operation 86 during which the processor calculates a number representing a desired value for the hashed function for the section i under consideration as: H(CDID⋄N⋄i). After completing operation 86, processor 72 advances to operation 88, during which the hashed function determined during operation 86 is stored as WMⱼᵣ. Then processor 72 advances to operation 90 during which the processor determines the bits in the watermark (WMⱼₐ) actually read from section j of the track or the CD.

If operation 80 determined that CDID was not readable from the header, processor 72 advances to operation 92, instead of operation 82. During operation 92, processor 72 sets the index register to i=(1). Then, during operation 94, processor 72 calculates H(N⋄k), that is, determines the hashing function of N concatenated with the number of the section being read from section k. Processor 72 then, during operation 96, reads the watermark of section k, WMₖₐ, and stores it in one of the registers of the processor. Processor 72 then determines, during operation 98, the hashed value of CDID, that is, H(CDID), by subtracting H(N⋄k) from WMₖₐ. Then, during operation 100, processor 72 calculates a desired value for the watermark of section j, that is, WMⱼᵣ, in accordance with: H(CDID)\hat{×}H(N⋄j).

Processor 72 then steps to operation 102. Operation 102 is performed immediately after operation 90 or operation 100, depending upon whether CDID was readable during operation 80. During operation 102 processor 72 determines if the calculated watermark for section j, WMⱼᵣ, is equal to the actually read watermark for section j. In response to operation 102 yielding a “yes” result, a register in processor 72 that stores the number of “yes” results is incremented by a count of one, operation 104. In response to operation 102 yielding a “no” result, a register in processor 72 that stores the number of “no” results is incremented by a count of one, operation 106. After operation 104 or 106, as applicable, has been performed, processor 72 steps to operation 108 during which the digital media content of section j is stored in a memory of the processor. Then, processor 72 advances to operation 110 during which the index register i is incremented by a count of one. Then processor 72 steps to operation 112, during which the processor determines if the count stored in the index register is equal to the number (N) of sections in the track or the CD. In response to operation 112 indicating that the count stored in the index register differs from the number of sections in the track or the CD, processor 72 returns to operation 86 or 94. Processor 72 returns to operation 86 if CDID was readable during operation 80, but returns to operation 94 if CDID was not readable during operation 80.

If operation 112 indicates that the count stored in the index register is equal to the number of sections in the track or the CD, processor 72 is ready to determine if the track or CD digital media content should be read out to speaker 62. To this end, processor 72 advances to operation 114, during which the register which stores the number of “no” results from operation 102 is read. In response to the contents of the “no” register exceeding a predetermined number, such as one, it can be assumed that the track or the CD was illicitly copied. In response to operation 114 indicating that the contents of the “no” register exceeds the predetermined number, processor 72 advances to operation 116 during which the memory storing the digital media content of the N sections of the track or the CD is erased. Consequently, the track or CD digital media content cannot be read out to speaker 62. In response to operation 114 indicating that the contents of the “no” register do not exceed the predetermined number, processor 72 advances to operation 118 during which the digital media content of sections 1 . . . k . . . N is read to speaker 62. It is to be understood that operation 114 can be replaced with some other operation, such as comparing the numbers stored in the “yes” and “no” registers; in such an instance, operation 118 is reached in response to the comparison indicating that the number stored in the “yes” register exceeds by a certain percentage the number stored in the “no” register. Upon completion of operation 116 or 118, whichever is applicable, the operations of processor 72 are completed and the program associated with these operations is exited.

While there has been described and illustrated a specific embodiment of the invention, it will be clear that variations in the details of the embodiment specifically illustrated and described may be made without departing from the true spirit and scope of the invention as defined in the appended claims. While the invention has been described in connection with preventing pirating of digital recording media, it is to be understood that it is related to applying and checking watermarks for many other purposes, e.g. secure distributed data storage.

I claim:

1. A method of applying watermarks WM₁ . . . WMₖ . . . WM_{N} to sections of 1 . . . k . . . N of digital content on a recording medium having an identification number (CDID) comprising combining numerical values representing CDID, N and k in accordance with a concatenated hashing function to derive a numerical value for WMᵢ, and applying the numerical value for WMₗ to section i, where i is selectively each of 1 . . . N.

2. A method of checking the watermark of section j of read digital content having watermarks applied in accordance with the method of claim 1 comprising determining the numerical values of CDID, j and N from the read digital content, determining the watermark WMⱼₐ actually read from section j, combining the determined numerical values of CDID, j and N by using the same hashing function that is used to derive WMᵢ to derive a digital signal for the watermark WMⱼᵣ that should be read from section j, and comparing the digital signal for the watermark WMⱼᵣ that should be read from section j with an indication of the numerical value for the watermark WMⱼₐ actually read from section j.

3. The method of claim 2 wherein CDID is read directly from the medium and WMⱼᵣ that should be read from section j is derived from H(CDID⋄N⋄j), where H is the hashing function and ⋄ is the concatenation of numbers.

4. The method of claim 2 wherein the correctness of the recorded CDID is determined by performing a calculation on value WMⱼₐ actually read from section j.

5. The method of claim 4 wherein H(CDID) is determined by subtracting H(Nⱼ) from the value of WMⱼₐ actually read from section j.

6. The method of claim 5 wherein the value that should be read from section j is calculated in accordance with H(N⋄j) to derive a first hashed function, and combining the first hashed function with the determined value of an invertible 2 argument operation that is hashed by hashing function H.

7. The method of claim 6 wherein the invertible 2 argument operation is an exclusive or function.

8. The method of claim 6 wherein the invertible 2 argument operation is a modular addition function.

9. A recording medium assigned with a numerical ID number (CDID), the medium including digital content, at least some of the digital content having watermarked sections 1 . . . i . . . N, the watermark in section i having a numerical value in accordance with a hashed concatenated function of CDID, N and i.

10. The apparatus of claim 9 wherein the digital content includes media content.

11. Apparatus for applying watermarks WM₁ . . . WMₖ . . . WM_{N} to sections 1 . . . k . . . N of a recording medium adapted to have an identification number (CDID) and to include digital content in at least sections 1 . . . k . . . N, the apparatus comprising a processor arrangement for combining for each of 1 . . . k . . . N digital signals indicative of CDID, k and N, the signals indicative of CDID, k and N being combined in accordance with a concatenated hashing function to derive a hashed concatenated output signal and a write unit for applying the hashed concatenated output signal to the recording medium.

12. Apparatus for checking the validity of digital watermarks in sections 1 . . . k . . . N, of a digital recording medium having an identification number (CDID) and digital content recorded in at least sections 1 . . . j . . . N of the medium, the apparatus comprising a read unit for reading the digital content and the watermarks and for deriving digital signals indicative thereof, a processor arrangement connected to be responsive to the read unit for determining (a) the numerical value of bits WMⱼᵣ in watermarks that should be recorded in at least some of sections 1 . . . j . . . N in accordance with a hashed function of concatenated values of a determined value of CDID combined with H, j and N, (b) the numerical values of bits WMⱼₐ actually read from the medium, and (c) the relative values of WMⱼᵣ and WMⱼₐ.

13. The apparatus of claim 11 wherein the processor arrangement is arranged to respond to CDID as read from the medium and for determining WMⱼᵣ and H(CDID⋄N⋄j), where H is the hashing function and ⋄ is the concatenation of numbers.

14. The apparatus of claim 12 wherein the processor arrangement is arranged for calculating the value of CDID in response to the value WMⱼₐ actually read from section j.

15. The apparatus of claim 14 wherein the processor arrangement is arranged to respond to CDID as read from the medium and for determining WMⱼᵣ as actually read from section j.

16. The apparatus of claim 15 wherein the processor arrangement is arranged to determine CDID by subtracting of H(N⋄k) from the value of WMⱼₐ actually read from section j.

17. The apparatus of claim 16 wherein the processor arrangement is arranged to (a) calculate the value that should be read from section j in accordance with H(N⋄j) to derive a first hashed function and (b) combine the first hashed function with the determined value of an invertible 2 argument operation that is hashed by hashing function H.

18. The apparatus of claim 17 wherein the invertible 2 argument operation is an exclusive or function.

19. The method of claim 1 wherein the number of bits in the numerical value of WMₖ is in the range of 20 to 24.

20. The method of claim 2 wherein the number of bits in the numerical value of WMₖ is in the range of 20 to 24.

21. The medium of claim 9 wherein the numerical value is represented by 20 to 24 bits.

22. The method of claim 11 wherein the number of bits in the numerical value of WMₖ is in the range of 20 to 24.

23. The apparatus of claim 12 wherein the number of bits in the numerical value of WMₖ is in the range of 20 to 24.
